(19) United States
(12) Patent Application Publication
(10) Pub. No.: US 2012/0287005 A1
(43) Pub. Date: Nov. 15, 2012

(54) MULTIBEAM ANTENNA SYSTEM

(76) Inventors: Jean-Franoics Pintos, Saint Blaise Du Buis (FR); Philippe Minard, Saint Medard Sur Ille (FR); Ali Louzir, Rennes (FR); Dominique Lo Hine Tong, Rennes (FR)

(21) Appl. No.: 13/458,566

(22) Filed: Apr. 27, 2012

(30) Foreign Application Priority Data
May 13, 2011 (FR) 1154154

(51) Int. Cl. H01Q 19/06

(52) U.S. Cl. 343/754

(57) ABSTRACT

The present invention relates to a multibeam antenna system comprising:
a substrate forming a ground plane,
a lens positioned on the substrate,
at least one radiating element to transmit and/or receive electromagnetic waves positioned around the lens, and
a switching means enabling the or at least one of the radiating elements to be selected, the lens being constituted by a cylindrical ring whose axis is perpendicular to the substrate.

The invention notably applies in multistandard terminals.

### FIELD OF THE INVENTION

The present invention relates to a multibeam antenna system, particularly a multibeam antenna system usable in the context of wireless communications, more particularly in the domestic networks in which the propagation conditions of electromagnetic waves are very penalising.

### TECHNICAL BACKGROUND

For emerging applications such as wireless domestic networks, smart networks or similar networks, the use of directive antennas, namely antennas with the faculty of focussing the radiated power in a particular direction of space, proves to be particularly attractive. Indeed, the use of directive antennas can reduce the power of transmitters and significantly limit interferences, the reduction in power of the transmitters is translated by a reduction of costs of equipment and/or increase in the lifetime of batteries and hence the autonomy of mobile equipment or wireless sensors.

However, the laws of physics require a minimum size for antennas, this size being all the greater as the antenna is directive or its operating frequency low. Hence, until now, the use of directive antennas has remained limited to antennas operating at very high frequencies, often at fixed frequencies, and not having size constraints such as radar applications or satellite applications.

However, to increase the capacity and bitrates of wireless systems, the emerging applications such as MIMO systems (for Multiple Input Multiple Output) use multiple antenna techniques. Hence, the grouping of directive antennas into networks is sometimes necessary to ensure point to point coverage in the entire space or on 360°. Moreover, to these more or less agile semi-directive antenna devices, a digital processing unit must be added to control and shape the beams in the directions required by the system. Indeed, the basic principle of a multibeam antenna system lies in the choice of one beam among a row of diverse fixed beams pointing in prioritised and predefined directions. The switching from one beam to another is decided according to, for example, the highest signal-to-noise ratio at reception.

Hence, in terms of integrated function within a multibeam antenna system, this must comprise a beam shaper that generates multiple beams, a listening circuit that is used for determining the beam to use to enable the optimal communication and a switch that is used to select the optimal beam for the reception. Therefore, the solutions currently on the market are complex solutions and, consequently, costly and/or bulky.

### SUMMARY OF THE INVENTION

The present invention thus proposes a multibeam antenna system that enables a response to the above problems by proposing a multibeam antenna system based on the joint use of a plastic lens and multiple sources.

Moreover, the present invention thus proposes a new compact multibeam antenna solution enabling pattern in different directions of space to be chosen with an extremely simple and non-expensive implementation technology.

The present invention relates to a multibeam antenna system comprising:
a substrate forming a ground plane,
a lens positioned on the substrate,
at least one radiating element to transmit and/or receive electromagnetic waves positioned around the lens, and
a switching means enabling the or at least one of the radiating elements to be selected, characterized in that the lens is constituted by a cylindrical ring whose axis is perpendicular to the substrate.

According to an embodiment, the cylindrical ring has in cross-section a circular or parallelepipedic shape. The circular ring has a thickness close to λg/4, where λg is the guided wavelength. This allows an optimisation of the thickness of the lens.

Moreover, the material of the lens is chosen from among plastic materials such as polymethylmethacrylate (known under the name plexiglas), acrylonitrile-butadiene styrene (known under the name ABS). Other materials such as ceramics or magneto-dielectric materials can also be used to produce the lens. The radiating elements, themselves, are chosen from among the monopoles, patches, slots. Moreover, each monopole is associated with a reflector positioned on the external surface of the lens so as to bring the radiation of the source in the direction of the lens.

According to another characteristic of the present invention, the different radiating elements are arranged in a circle surrounding the lens. The distribution of the radiating elements in a circle increases the uniformity, namely the symmetry, of the radiation patterns between each other

### BRIEF DESCRIPTION OF THE DRAWINGS

Other characteristics and advantages of the present invention will emerge upon reading the following description of an embodiment, this description being made with reference to the drawings attached in the appendix, in which:

FIG. 1 is a diagrammatic perspective view of an embodiment of a multibeam antenna system in accordance with the present invention.

FIG. 2 shows the different radiation patterns as a function of the access.

FIG. 3 shows the radiation pattern of the system of FIG. 1 as a function of frequency.

FIG. 4 shows a curve indicating the impedance matching as a function of frequency for the different radiating elements of the system in FIG. 1.

### DESCRIPTION OF AN EMBODIMENT

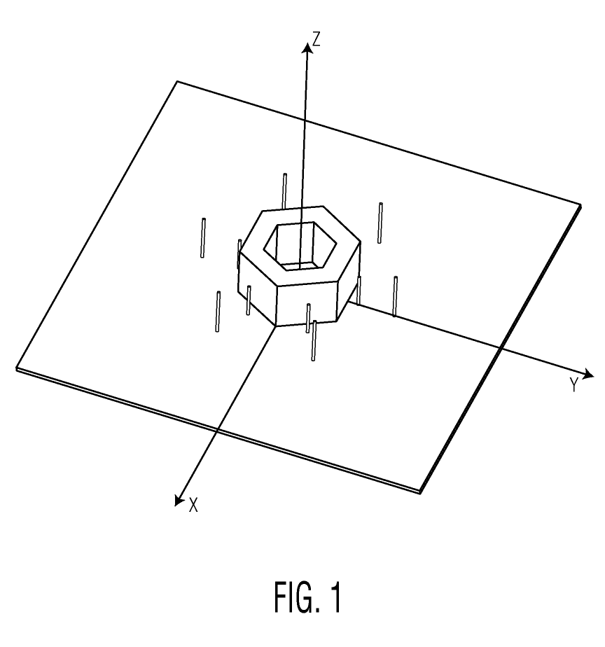

As shown in FIG. 1, in the centre of a substrate 1 forming a ground plane a lens 2 is mounted. This lens 2 is a part in plastic material, which has been machined or moulded. In the embodiment shows, the lens is made using polymethylmethacrylate or plexiglas which has a permittivity εr=3.4 and a tangent D=0.001. However, it is evident to those in the profession that the lens can be produced in other materials such as acrylonitrile-butadiene styrene known under the name ABS or in ceramic or magneto-dielectric materials.

More generally, any material having a permittivity and/or a permeability different from 1 can be used to produce the lens. In the embodiment of FIG. 1, the lens has the shape of a cylindrical ring with a parallelepipedic cross-section, more particularly hexagonal. However, the lens can have a circular ring shape.

As shown in FIG. 1, radiating elements constituted by monopoles 3₁, 3₂, 3₃, 3₄, 3₅, 3₆ are positioned on the substrate 1 around lens 2. Preferentially, these radiating elements are placed symmetrically on a circle to obtain a uniformity of radiation patterns between each other.

In FIG. 1, each radiating element 3₁ to 3₆ is positioned in the middle of one face of the hexagonal lens. Moreover, in the embodiment shown, the monopoles are quarterwave monopoles. Each monopole is associated with a reflective element 4 positioned in front of the lens, which enables the radiation of the source to be brought in the direction of the lens. It is evident to a person skilled in the art that the radiating elements can be constituted by elements other than monopoles, namely patches or possibly slots.

According to a characteristic of the present invention, the thickness of the ring forming lens 2 was optimised to be close to λg/4 where λg is the guided wavelength and is equal to

$$\frac{λ 0}{\sqrt{ɛ r μ r}} ,$$

with λ0 the wavelength in a vacuum, εr the permittivity and μr the permeability of the material forming the lens.

A description will now be made of the embodiment according to the configuration of FIG. 1, which was used to conduct simulations by using the 3D electromagnetic software HFSS of the ANSYS company, based on the finite element method. In this case the following dimensions were used.

The substrate is a substrate in a known material FR4 formed by a square of length ˜2.75λ0.

The distance between the centre of a reflective strand 4 and the centre of a radiating element is 0.15λ0.

The distance between a radiating element 3 and the external wall of the lens 2 is 0.0725λ0.

The internal diameter of the lens 2 is 0.4λ0.

The height of a reflective strand 4 is 0.3λ0.

The height of a monopole is 0.25λ0.

The height of the plastic lens is 0.367λ0.

As shown in FIG. 1, the distance between two diametrically opposed reflectors in relation to an x access is ˜1.12λ0.

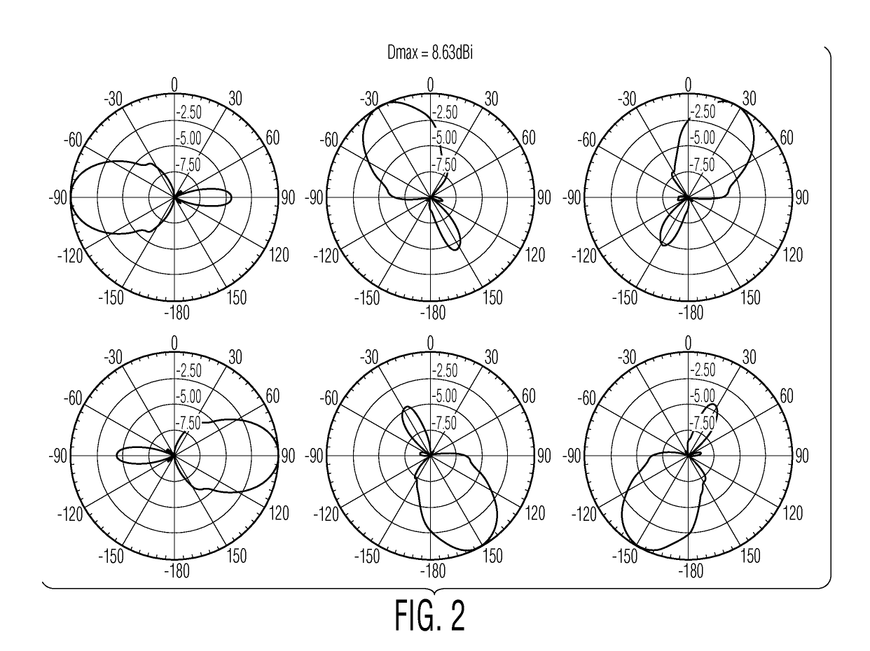

By using the aforementioned dimensions, different patterns and curves shown in FIGS. 2 to 4 were obtained.

FIG. 2 shows that by exciting the accesses of the six monopoles 3₁ to 3₆ separately, six standard radiation patterns of the total field are obtained pointing in six different directions of space. Hence, it is possible to cover the entire azimuthal plane while offering a spatial filtering with respect to interfering elements positioned in other angular sectors. To do this, the radiating elements 3₁ to 3₆ can be connected to a switching matrix not shown in FIG. 1, which serves as an interface between a MIMO type digital circuit and which enables three sectors among the six available to be chosen.

It is also evident that, in the antenna system of FIG. 1, all the radiating elements can be used simultaneously if necessary.

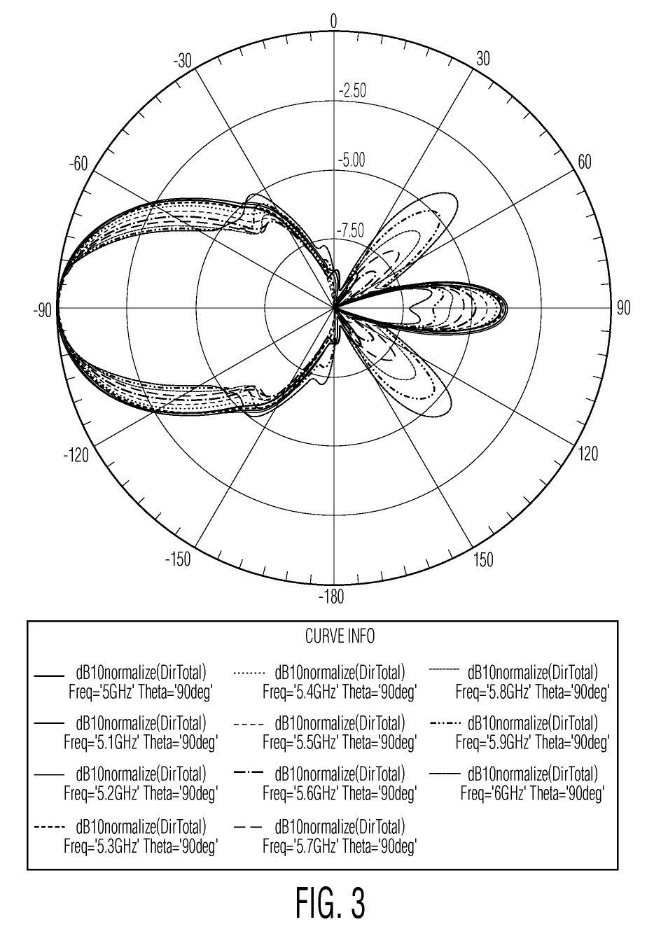

In FIG. 3, the standard radiation patterns of the total field were shown as a function of frequency for an access between 5 GHz and 6 GHz. The curves shown in FIG. 3 show that the radiation remains uniform overall, namely that the opening at +/−30° is respected for an oscillating level between −2.5 dB and −4 dB with respect to the maximum.

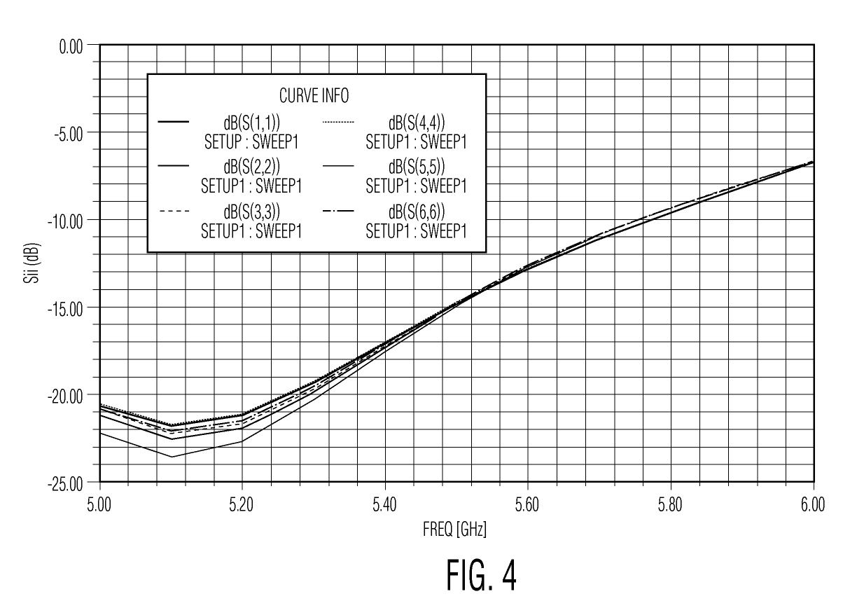

The curves of FIG. 4 show that the impedance matching levels are less than −10 dB up to a frequency of around 5.75 GHz. These levels can be readjusted to cover the entire WiFi band at 5 GHz by optimising, for example, the geometry of the lens or by adding an impedance matching network.

The embodiment described above is a simple and low cost embodiment using low cost materials such as a plastic material for the lens, an FR4 type substrate for the substrate and metal strands for the radiating elements and reflective elements. Moreover, the dimensions of the lens, namely the interior and exterior diameters of the ring, the distance between the source and the reflective element, the distance between the wall of the lens as well as the height and position of the lens and the number of sources, make it possible to optimise the directivity and the level of matching in the targeted frequency band.

What is claimed is:

1- Multibeam antenna system comprising:
a substrate forming a ground plane,
a lens positioned on the substrate,
at least one radiating element to transmit and/or receive electromagnetic waves positioned around the lens, and
a switching means enabling the or at least one of the radiating elements to be selected,
wherein the lens is constituted by a cylindrical ring whose axis is perpendicular to the substrate.

2- Antenna system according to claim 1, wherein the cylindrical ring has in cross-section a circular or parallelepipedic shape.

3- Antenna system according to claim 2, wherein the circular ring has a thickness close to λg/4 where λg is the guided wavelength, with
$$\frac{λ 0}{\sqrt{ɛ r μ r}}$$
(λ0 the wavelength in a vacuum, εr and μr respectively the permittivity and permeability of the material forming the lens).

4- Antenna system according to claim 1, wherein the material of the lens is chosen from among plastic materials such as polymethylmethacrylate (plexiglas), acrylonitrile butadiene styrene (ABS), ceramics, magneto dielectric materials.

5- Antenna system according to claim 1 wherein the radiating elements are chosen from among the monopoles, patches, slots.

6- Antenna system according to claim 5, wherein each monopole positioned near the external surface of the lens is associated with a reflector.

7- Antenna system according to claim 1, wherein the radiating elements are positioned on a circle circumscribing the lens.
